(19) United States
(12) Patent Application Publication
(10) Pub. No.: US 2020/0153629 A1
(43) Pub. Date: May 14, 2020

(54) TRUSTED EXECUTION AWARE HARDWARE DEBUG AND MANAGEABILITY

(71) Applicant: Intel Corporation, Santa Clara, CA (US)

(72) Inventors: Salessawi Ferede Yitbarek, Hillsboro, OR (US); Luis Kida, Beaverton, OR (US); Vincent Scarlata, Beaverton, OR (US); Reshma Lal, Portland, OR (US); Simon Johnson, Beaverton, OR (US)

(73) Assignee: Intel Corporation, Santa Clara, CA (US)

(21) Appl. No.: 16/723,599

(22) Filed: Dec. 20, 2019

(51) Int. Cl. H04L 9/32; H04L 9/08; G06F 21/60

(52) U.S. Cl. CPC H04L 9/321; G06F 2221/2101; G06F 21/602; H04L 9/0894

(57) ABSTRACT

A method comprises initializing a compute platform in a cloud computing environment, assigning at least a first cryptographic key associated with the platform manufacturer and a second cryptographic key associated with a workload owner to a debug/management interface of the compute platform, and encrypting device information generated by the debug/management interface of the compute platform using at least one of the first cryptographic key or the second cryptographic key.

### BACKGROUND

In a cloud computing system, confidential information is stored, transmitted, and used by many different information processing systems. In some examples a platform owner, such as a cloud service provider, may have the ability to access hardware debug and management information of an accelerator device of a cloud platform, even while the device is running production workloads. However, a cloud customer purchasing a confidential computing service from a cloud service provider may not be willing to trust a device with enabled debug interfaces, since those interfaces may be abused by unauthorized personnel, e.g., at the cloud service provider, to extract sensitive data. This issue could be addressed by turning off all forms of debug and management interfaces during trusted execution workloads, but this would prevent the platform owner from getting access to information that can be valuable in debugging hard-to-reproduce bugs.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a schematic illustration of a processing environment in which systems and methods for trusted execution aware hardware debug and manageability may be implemented, according to embodiments.

FIG. 2 is a simplified block diagram of an example system including an example platform supporting trusted execution aware hardware debug and manageability in accordance with an embodiment.

FIG. 3 is a simplified block diagram representing application attestation in accordance with one embodiment.

FIG. 4 is a simplified, high-level flow diagram of at least one embodiment of a method for trusted execution aware hardware debug and manageability according to an embodiment.

FIGS. 5-7 are diagrams illustrating operational flows in various examples of a method for trusted execution aware hardware debug and manageability according to an embodiment.

FIG. 8 is a block diagram illustrating a computing architecture which may be adapted to provide a method for certifying a trusted platform module (TPM) without privacy infrastructure according to an embodiment.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C) Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

Example Cloud Computing Environment with Trusted Execution

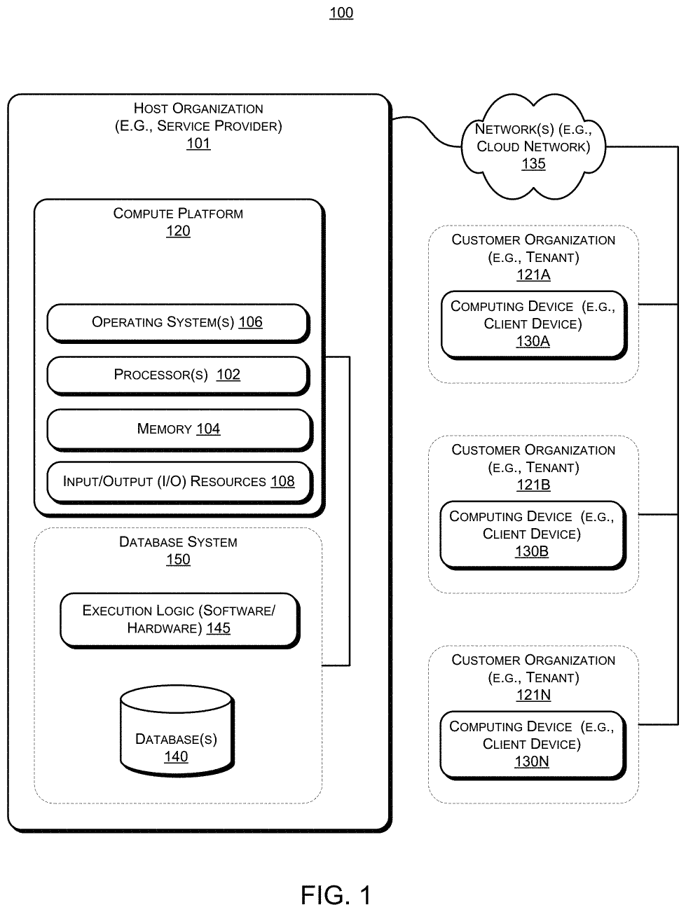

FIG. 1 is a schematic illustration of a processing environment in which systems and methods for trusted execution aware hardware debug and manageability may be implemented, according to embodiments. Referring to FIG. 1, a system 100 may comprise a compute platform 120. In one embodiment, compute platform 120 includes one or more host computer servers for providing cloud computing services. Compute platform 120 may include (without limitation) server computers (e.g., cloud server computers, etc.), desktop computers, cluster-based computers, set-top boxes (e.g., Internet-based cable television set-top boxes, etc.), etc. Compute platform 120 includes an operating system (“OS”) 106 serving as an interface between one or more hardware/physical resources of compute platform 120 and one or more client devices 130A-130N, etc. Compute platform 120 further includes processor(s) 102, memory 104, input/output (“I/O”) sources 108, such as touchscreens, touch panels, touch pads, virtual or regular keyboards, virtual or regular mice, etc.

In one embodiment, host organization 101 may further employ a production environment that is communicably interfaced with client devices 130A-N through host organization 101. Client devices 130A-N may include (without limitation) customer organization-based server computers, desktop computers, laptop computers, mobile compute platforms, such as smartphones, tablet computers, personal digital assistants, e-readers, media Internet devices, smart televisions, television platforms, wearable devices (e.g., glasses, watches, bracelets, smartcards, jewelry, clothing items, etc.), media players, global positioning system-based navigation systems, cable setup boxes, etc.

In one embodiment, the illustrated database system 150 includes database(s) 140 to store (without limitation) information, relational tables, datasets, and underlying database records having tenant and user data therein on behalf of customer organizations 121A-N (e.g., tenants of database system 150 or their affiliated users). In alternative embodiments, a client-server computing architecture may be utilized in place of database system 150, or alternatively, a computing grid, or a pool of work servers, or some combination of hosted computing architectures may be utilized to carry out the computational workload and processing that is expected of host organization 101.

The illustrated database system 150 is shown to include one or more of underlying hardware, software, and logic elements 145 that implement, for example, database functionality and a code execution environment within host organization 101. In accordance with one embodiment, database system 150 further implements databases 140 to service database queries and other data interactions with the databases 140. In one embodiment, hardware, software, and logic elements 145 of database system 150 and its other elements, such as a distributed file store, a query interface, etc., may be separate and distinct from customer organizations (121A-121N) which utilize the services provided by host organization 101 by communicably interfacing with host organization 101 via network(s) 135 (e.g., cloud network, the Internet, etc.). In such a way, host organization 101 may implement on-demand services, on-demand database services, cloud computing services, etc., to subscribing customer organizations 121A-121N.

In some embodiments, host organization 101 receives input and other requests from a plurality of customer organizations 121A-N over one or more networks 135; for example, incoming search queries, database queries, application programming interface (“API”) requests, interactions with displayed graphical user interfaces and displays at client devices 130A-N, or other inputs may be received from customer organizations 121A-N to be processed against database system 150 as queries via a query interface and stored at a distributed file store, pursuant to which results are then returned to an originator or requestor, such as a user of client devices 130A-N at any of customer organizations 121A-N.

As aforementioned, in one embodiment, each customer organization 121A-N may include an entity selected from a group consisting of a separate and distinct remote organization, an organizational group within host organization 101, a business partner of host organization 101, a customer organization 121A-N that subscribes to cloud computing services provided by host organization 101, etc.

In one embodiment, requests are received at, or submitted to, a server within host organization 101. Host organization 101 may receive a variety of requests for processing by host organization 101 and its database system 150. For example, incoming requests received at the server may specify which services from host organization 101 are to be provided, such as query requests, search request, status requests, database transactions, graphical user interface requests and interactions, processing requests to retrieve, update, or store data on behalf of one of customer organizations 121A-N, code execution requests, and so forth. Further, the server at host organization 101 may be responsible for receiving requests from various customer organizations 121A-N via network(s) 135 on behalf of the query interface and for providing a web-based interface or other graphical displays to one or more end-user client devices 130A-N or machines originating such data requests.

Further, host organization 101 may implement a request interface via the server or as a stand-alone interface to receive requests packets or other requests from the client devices 130A-N. The request interface may further support the return of response packets or other replies and responses in an outgoing direction from host organization 101 to one or more client devices 130A-N.

It is to be noted that terms like “node”, “computing node”, “server”, “server device”, “cloud computer”, “cloud server”, “cloud server computer”, “machine”, “host machine”, “device”, “compute platform”, “computer”, “computing system”, “multi-tenant on-demand data system”, and the like, may be used interchangeably throughout this document. It is to be further noted that terms like “code”, “software code”, “application”, “software application”, “program”, “software program”, “package”, “software code”, “code”, and “software package” may be used interchangeably throughout this document. Moreover, terms like “job”, “input”, “request”, and “message” may be used interchangeably throughout this document.

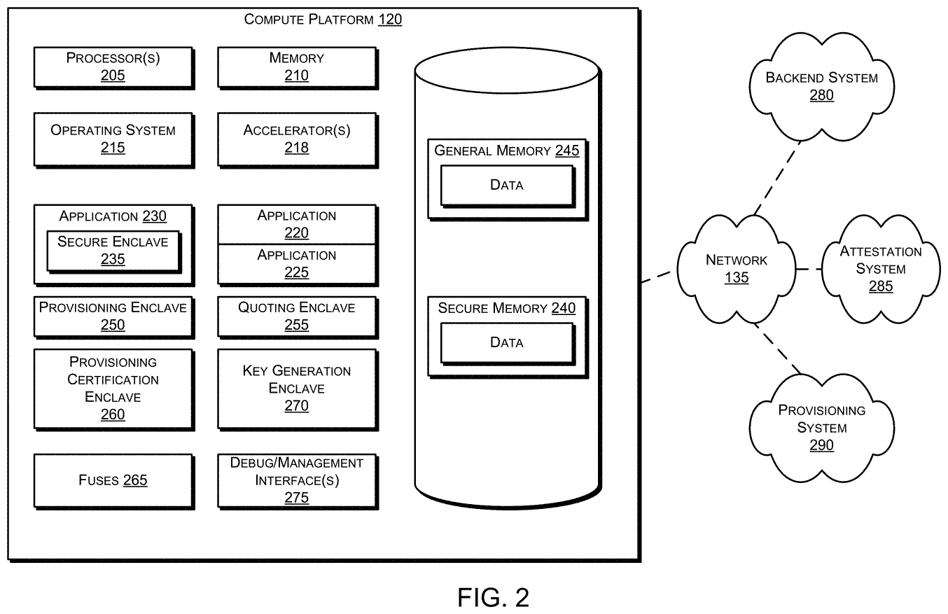

FIG. 2 is a simplified block diagram of an example system including an example compute platform 120 supporting trusted execution aware hardware debug and manageability in accordance with an embodiment. Referring to the example of FIG. 2, a compute platform 120 can include one or more processor devices 205, one or more memory elements 210, and other components implemented in hardware and/or software, including an operating system 215 and a set of applications (e.g., 220, 225, 230), and one or more accelerators 218 (e.g., a graphics processor, image processor, matrix processor, or the like). One or more of the applications may be implemented in a trusted execution environment secured using, for example, a secure enclave 235, or application enclave. Secure enclaves can be implemented using secure memory 240 (as opposed to general memory 245) and utilizing secured processing functionality of at least one of the processors (e.g., 205) of the compute platform 120 to implement private regions of code and data to provide secured or protected execution of the application. Logic, implemented in firmware and/or software of the compute platform (such as code of the CPU of the host), can be provided on the compute platform 120 that can be utilized by applications or other code local to the compute platform to set aside private regions of code and data, which are subject to guarantees of heightened security, to implement one or more secure enclaves on the system. For instance, a secure enclave can be used to protect sensitive data from unauthorized access or modification by rogue software running at higher privilege levels and preserve the confidentiality and integrity of sensitive code and data without disrupting the ability of legitimate system software to schedule and manage the use of platform resources. Secure enclaves can enable applications to define secure regions of code and data that maintain confidentiality even when an attacker has physical control of the platform and can conduct direct attacks on memory. Secure enclaves can further allow consumers of the host devices (e.g., compute platform 120) to retain control of their platforms including the freedom to install and uninstall applications and services as they choose. Secure enclaves can also enable compute platform 200 to take measurements of an application's trusted code and produce a signed attestation, rooted in the processor, that includes this measurement and other certification that the code has been correctly initialized in a trustable execution environment (and is capable of providing the security features of a secure enclave, such as outlined in the examples above).

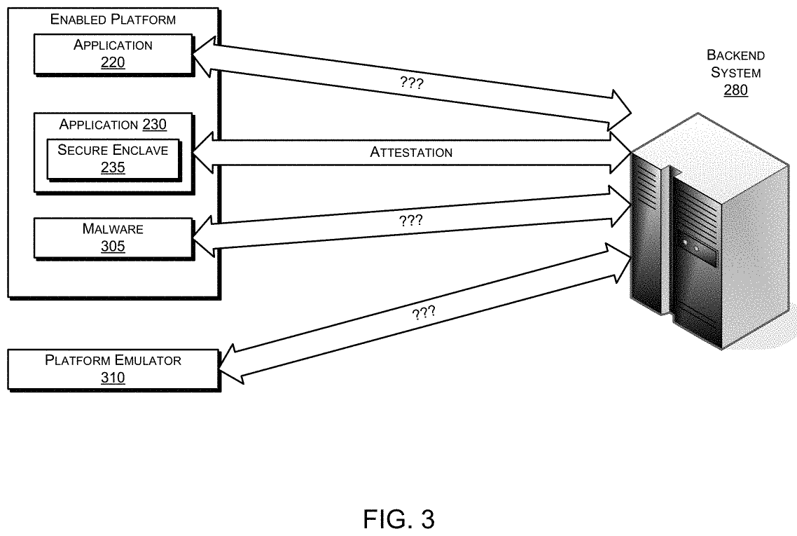

Turning briefly to FIG. 3, an application enclave (e.g., 235) can protect all or a portion of a given application 230 and allow for attestation of the application 230 and its security features. For instance, a service provider in backend system 280, such as a backend service or web service, may prefer or require that clients with which it interfaces, possess certain security features or guarantees, such that the backend system 280 can verify that it is transacting with who it the client says it is. For instance, malware (e.g., 305) can sometimes be constructed to spoof the identity of a user or an application in an attempt to extract sensitive data from, infect, or otherwise behave maliciously in a transaction with the backend system 280. Signed attestation (or simply “attestation”) can allow an application (e.g., 230) to verify that it is a legitimate instance of the application (i.e., and not malware). Other applications (e.g., 220) that are not equipped with a secure application enclave may be legitimate, but may not attest to the backend system 280, leaving the service provider in doubt, to some degree, of the application's authenticity and trustworthiness. Further, compute platform platforms (e.g., 200) can be emulated (e.g., by emulator 310) to attempt to transact falsely with the backend system 280. Attestation through a secure enclave can guard against such insecure, malicious, and faulty transactions.

Returning to FIG. 2, attestation can be provided on the basis of a signed piece of data, or “quote,” that is signed using an attestation key securely provisioned on the platform. Additional secured enclaves can be provided (i.e., separate from the secure application enclave 235) to measure or assess the application and its enclave 235, sign the measurement (included in the quote), and assist in the provisioning of one or more of the enclaves with keys for use in signing the quote and established secured communication channels between enclaves or between an enclave and an outside service (e.g., backend system 280, attestation system 105, provisioning system 130, backend system 140). For instance, one or more provisioning enclaves 250 can be provided to interface with a corresponding provisioning system to obtain attestation keys for use by a quoting enclave 255 and/or application enclave. One or more quoting enclaves 255 can be provided to reliably measure or assess an application 230 and/or the corresponding application enclave 235 and sign the measurement with the attestation key obtained through the corresponding provisioning enclave 250. A provisioning certification enclave 260 may also be provided to authenticate a provisioning enclave (e.g., 250) to its corresponding provisioning system (e.g., 120). The provisioning certification enclave 260 can maintain a provisioning attestation key that is based on a persistently maintained, secure secret on the host platform 200, such as a secret set in fuses 265 of the platform during manufacturing, to support attestation of the trustworthiness of the provisioning enclave 250 to the provisioning system 290, such that the provisioning enclave 250 is authenticated prior to the provisioning system 290 entrusting the provisioning enclave 250 with an attestation key. In some implementations, the provisioning certification enclave 260 can attest to authenticity and security of any one of potentially multiple provisioning enclaves 250 provided on the platform 200. For instance, multiple different provisioning enclaves 250 can be provided, each interfacing with its own respective provisioning system, providing its own respective attestation keys to one of potentially multiple quoting enclaves (e.g., 255) provided on the platform. For instance, different application enclaves can utilize different quoting enclaves during attestation of the corresponding application, and each quoting enclave can utilize a different attestation key to support the attestation, e,g., via an attestation system 285. Further, through the use of multiple provisioning enclaves 250 and provisioning services provided, e.g., by one or more provisioning systems 290, different key types and encryption technologies can be used in connection with the attestation of different applications and services (e.g., hosted by backend systems 280).

In some implementations, rather than obtaining an attestation key from a remote service (e.g., provisioning system 120), one or more applications and quoting enclaves can utilize keys generated by a key generation enclave 270 provided on the platform. To attest to the reliability of the key provided by the key generation enclave, the provisioning certification enclave can sign the key (e.g., the public key of a key pair generated randomly by the key generation enclave) such that quotes signed by the key can be identified as legitimately signed quotes. In some cases, key generation enclaves (e.g., 270) and provisioning enclaves (e.g., 250) can be provided on the same platform, while in other instances, key generation enclaves (e.g., 270) and provisioning enclaves (e.g., 250) can be provided as alternatives for the other (e.g., with only a key generation enclave or provisioning enclaves be provided on a given platform), among other examples and implementations.

### Trusted Execution Hardware Debut and Manageability

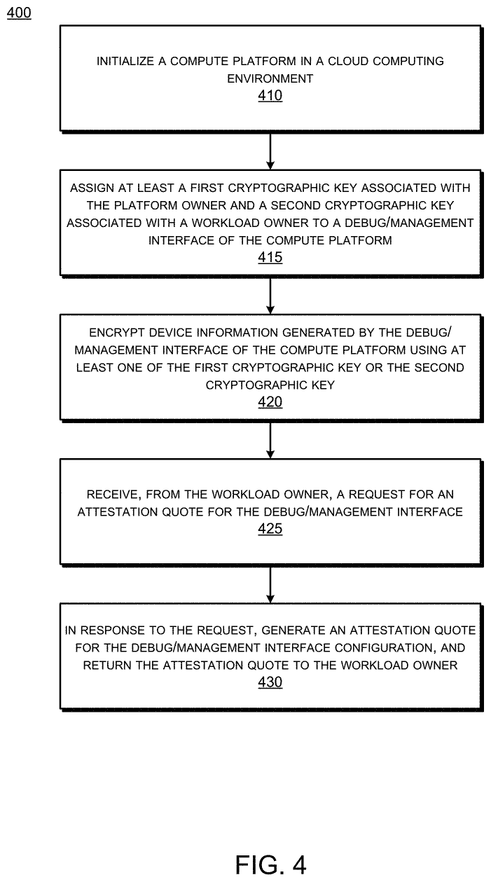

Having described various structures and components for trusted execution aware hardware debug and manageability, operations and data flows will now be described with reference to FIGS. 4-7.

FIG. 4 is a simplified, high-level flow diagram of at least one embodiment of a method 400 for trusted execution aware hardware debug and manageability according to an embodiment. Referring to FIG. 4, at operation 410 a platform owner may initialize a compute platform in a cloud computing environment. In some examples the compute platform may correspond to the compute platform 120 depicted in FIG. 1 and FIG. 2 and may comprise one or more debug/management interfaces 275 in compute platform 120. In some examples the one or more management/debut interfaces may comprise a Joint Test Action Group (JTAG) interface, which is a standardized interface that provides a test access port (TAP) and associated protocol to access a test registers that present chip logic levels and device capabilities of various parts.

At operation 415 the platform owner may assign to the debug/management interface at least a first cryptographic key associated with the platform manufacturer and a second cryptographic key associated with the owner of a workload that is to execute on the compute platform. In some examples the cryptographic keys may be public keys that are part of a private/public key pair and may be either symmetric keys or asymmetric keys.

At operation 420 device information generated by the debug/management interface may be encrypted using at least one of the first cryptographic key or the second cryptographic key. For example, when information is encrypted with the first cryptographic key associated with the platform manufacturer, then the platform manufacturer can decrypt information extracted from the debug/management interface using its private key that is associated with the first cryptographic key Similarly, when information is encrypted with the second cryptographic key associated with the workload owner, then the workload owner can decrypt information extracted from the debug/management interface using its private key that is associated with the second cryptographic key. In some examples the workload owner may also use its cryptographic key to access the debug/management interface to inspect which data the platform owner is allowed to access and under what circumstances the data may be accessed.

At operation 425 a request for an attestation quote for the debug/management interface may be received from the workload owner. In some examples the request may be directed to an accelerator device such as the accelerator(s) 218 depicted in FIG. 2. In response to the request, at operation 430, the accelerator(s) 218 generates an attestation quote for the debug/management interface and returns the attestation quote to the workload owner. In some examples the attestation quote may comprise information such as which debug interfaces on the accelerator(s) 218 are enabled and, for those debug interfaces that are enabled, which entities can decrypt the debug logs, i.e., which entities have public keys to decrypt the logs.

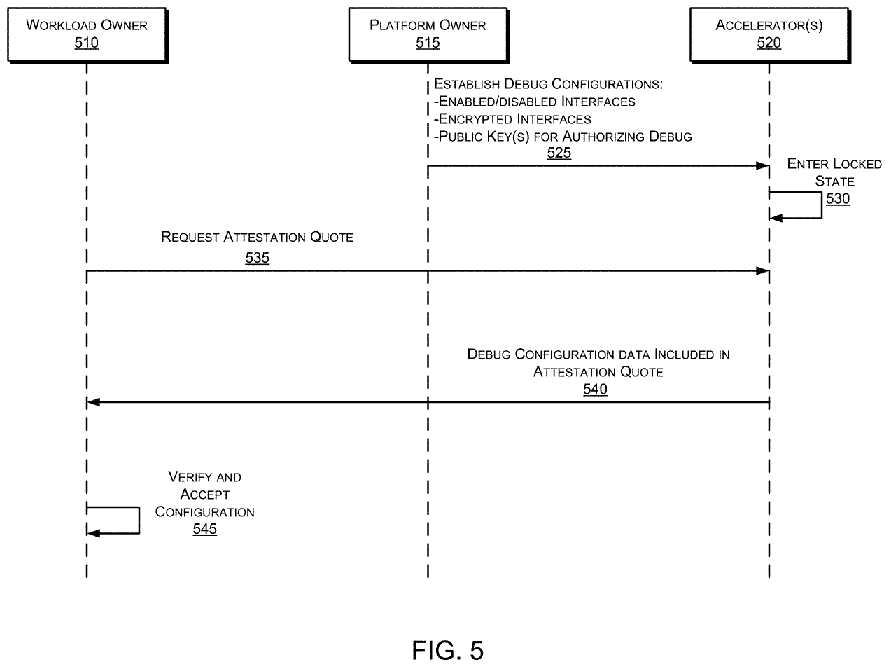

FIGS. 5-7 are diagrams illustrating operational flows in various examples of a method for trusted execution aware hardware debug and manageability according to an embodiment. FIG. 5 depicts an example of operational flows between a workload owner 510, a platform owner 515, and one or more accelerators 520 in an overview of a configuration operation. Referring to FIG. 5, at operation 525 a platform owner establishes and transmits a debug configuration for the debug/management interface to the accelerator(s) 520. In some examples the debug configuration may comprise identifiers of one or more enable and/or disabled debug/management interfaces, identifiers of one or more encrypted debug/management interfaces, and one or more public keys for authorizing a debug operation.

In response to receiving the configuration information, at operation 530 the accelerator(s) enter a locked state in which the accelerator(s) will reject any further configuration changes to the debug/management interface(s) on the accelerator(s) 520. At operation 535 the workload owner 510 requests an attestation quote from the accelerator(s) 520. In response to the request, at operation 540, the accelerator(s) 520 generate and returns to the workload owner 510 an attestation quote which includes the debug data for the accelerator(s) 520. At operation 545 the workload owner verifies the attestation quote (e.g., using the private key of the public/private key pair associated with the accelerator(s) 520) and accepts the configuration of the accelerator(s) 520. Thus, the workload owner understands the configuration of the accelerator(s) 520.

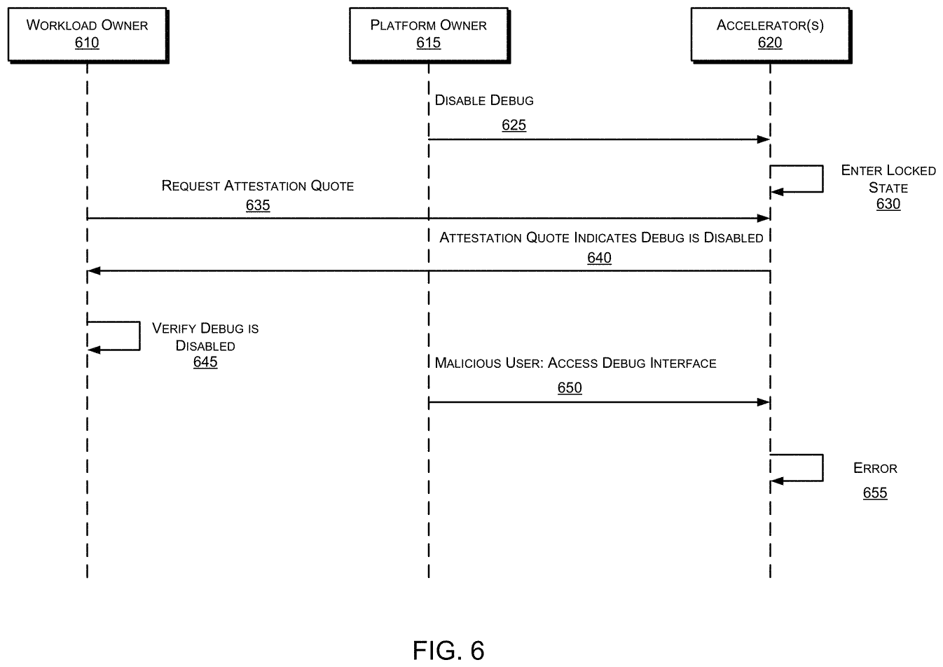

FIG. 6 depicts an example of operational flows between a workload owner 610, a platform owner 615, and one or more accelerators 620 in a situation in which all debug and management options are disabled. Referring to FIG. 6, at operation 625 a platform owner 615 transmits a disable debug request to the accelerator(s) 620. In response to receiving the disable debug request, at operation 630 the accelerator(s) 620 enter a locked state in which the accelerator(s) will reject any further configuration changes to the debug/management interface(s) on the accelerator(s) 620. At operation 635 the workload owner 510 requests an attestation quote from the accelerator(s) 620. In response to the request, at operation 640, the accelerator(s) 620 generate and returns to the workload owner 610 an attestation quote which indicates that debug is disabled for the accelerator(s) 620. At operation 645 the workload owner verifies that debug is disabled.

At operation 650 a malicious user on the platform attempts to access the debug interface. In response to the attempt, at operation 655, the accelerator(s) 620 generate an error report. In some examples the accelerator(s) 620 may enter the entity that generated the malicious attempt to access the debug interface into a log of malicious users.

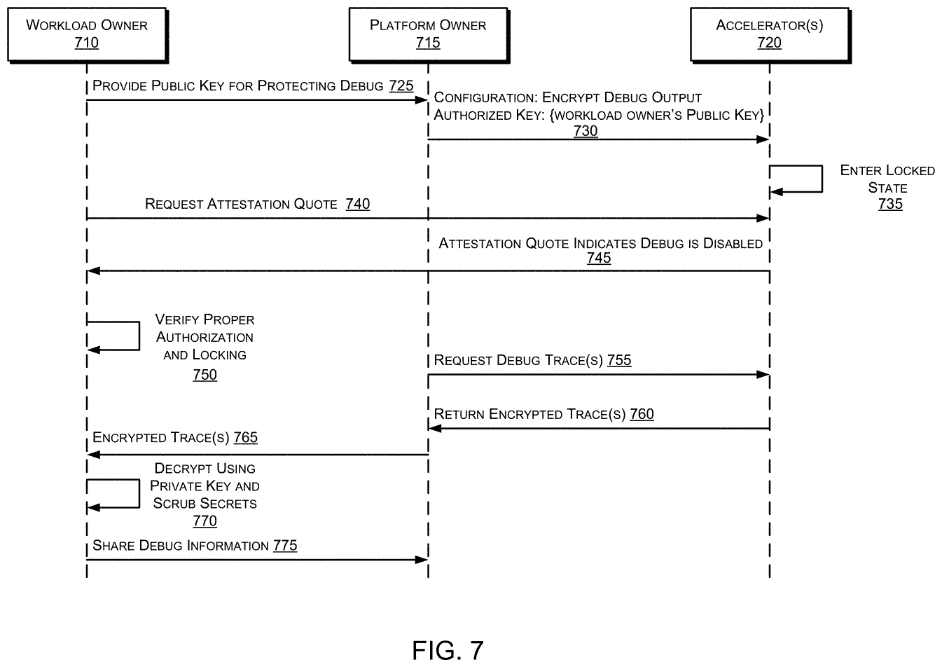

FIG. 7 depicts an example of operational flows between a workload owner 710, a platform owner 715, and one or more accelerators 720 in a situation in which all debug traces are encrypted using a workload owner's cryptographic key. In some examples encrypted debug/management traces are available. An attestation process reflects the public key of the entity that can decrypt these traces. This public key could correspond to the workload owner, platform owner, or device manufacturer depending on the context. A subset of features such as temperature sensors, frequency sensors, or aggregate statistics are enabled, but other features such as direct access to data or traces are disabled. Enabled features may be encrypted as above or in the clear if the OS needs them. In some examples attestation reflects which features are enabled, and if they are encrypted, the public encryption key

Referring to FIG. 7, at operation 725 a workload owner provides a platform owner 715 with a public key for protecting a debug/management interface. At operation 730 the platform owner transmits a debug configuration for the debug/management interface to the accelerator(s) 720. In some examples the debug configuration may comprise one or more of the workload owner's public keys for authorizing a debug operation. In response to receiving the disable debug request, at operation 735 the accelerator(s) 720 enter a locked state in which the accelerator(s) will reject any further configuration changes to the debug/management interface(s) on the accelerator(s) 720. At operation 740 the workload owner 710 requests an attestation quote from the accelerator(s) 720. In response to the request, at operation 745, the accelerator(s) 620 generate and returns to the workload owner 710 an attestation quote which includes the debug configuration for the accelerator(s) 720. At operation 750 the workload owner verifies that it has the proper authorization and initiates locking.

At operation 755 the platform owner 715 requests a debug trace from the accelerator(s) 720. In response to the request, at operation 560, the accelerator(s) 520 generate and, at operation 760 returns to the platform owner 510 an encrypted debug trace which, at operation 765, returns the encrypted trace to the workload owner 710. At operation 770 the workload owner 710 decrypts the traces (e.g., using the private key of the public/private key pair associated with the accelerator(s) 720) and at operation 775 the workload shares the debug information with the platform owner 715 after scrubbing any privacy sensitive data.

In some examples, after reporting the state of the JTAG controller, block the control from changing the state of test access ports (TAPs) of the controller (or filter test mode select (TMS), test clock (TCK) to force a state which the TAP is kept in a reset state, a boundary scan, a BYPASS mode, or a HIGHZ mode. Alternatively, the state of the TAP control may be monitored to detect an exit from a reset state, an entrance to a shift state, selection of a protected scan chain, or blocking and monitoring for an attempt of change.

### EXAMPLES

### Exemplary Computing Architecture

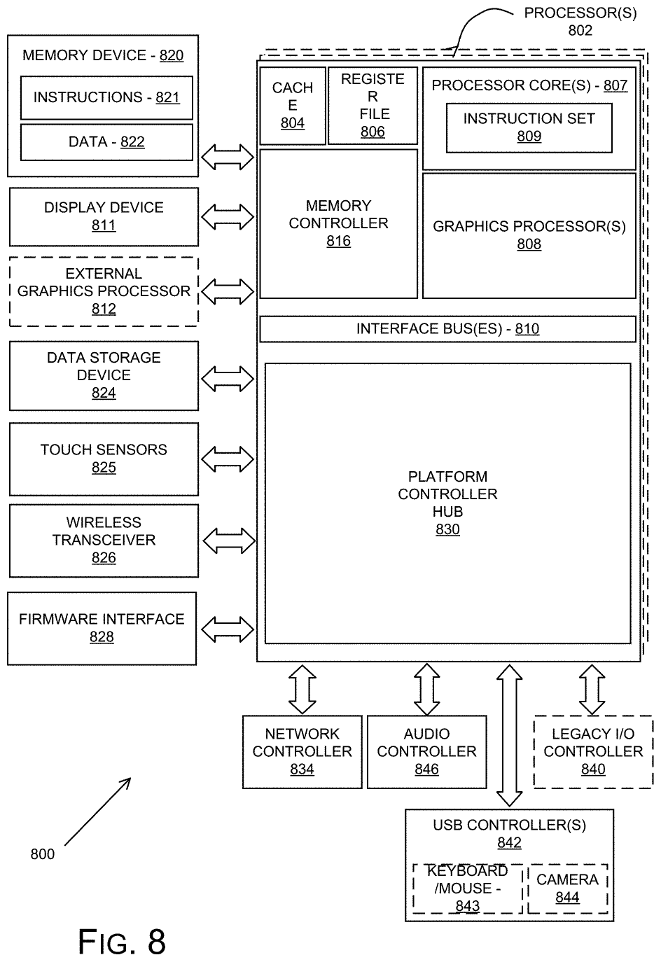

FIG. 8 is a block diagram illustrating a computing architecture which may be adapted to implement a secure address translation service using a permission table (e.g., HPT 135 or HPT 260) and based on a context of a requesting device in accordance with some examples. The embodiments may include a computing architecture supporting one or more of (i) verification of access permissions for a translated request prior to allowing a memory operation to proceed; (ii) prefetching of page permission entries of an HPT responsive to a translation request; and (iii) facilitating dynamic building of the HPT page permissions by system software as described above.

In various embodiments, the computing architecture 800 may comprise or be implemented as part of an electronic device. In some embodiments, the computing architecture 800 may be representative, for example, of a computer system that implements one or more components of the operating environments described above. In some embodiments, computing architecture 800 may be representative of one or more portions or components in support of a secure address translation service that implements one or more techniques described herein.

As used in this application, the terms “system” and “component” and “module” are intended to refer to a computer-related entity, either hardware, a combination of hardware and software, software, or software in execution, examples of which are provided by the exemplary computing architecture 800. For example, a component can be, but is not limited to being, a process running on a processor, a processor, a hard disk drive or solid state drive (SSD), multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the unidirectional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 800 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 800.

As shown in FIG. 8, the computing architecture 800 includes one or more processors 802 and one or more graphics processors 808, and may be a single processor desktop system, a multiprocessor workstation system, or a server system having a large number of processors 802 or processor cores 807. In on embodiment, the system 800 is a processing platform incorporated within a system-on-a-chip (SoC or SOC) integrated circuit for use in mobile, handheld, or embedded devices.

An embodiment of system 800 can include, or be incorporated within, a server-based gaming platform, a game console, including a game and media console, a mobile gaming console, a handheld game console, or an online game console. In some embodiments system 800 is a mobile phone, smart phone, tablet computing device or mobile Internet device. Data processing system 800 can also include, couple with, or be integrated within a wearable device, such as a smart watch wearable device, smart eyewear device, augmented reality device, or virtual reality device. In some embodiments, data processing system 800 is a television or set top box device having one or more processors 802 and a graphical interface generated by one or more graphics processors 808.

In some embodiments, the one or more processors 802 each include one or more processor cores 807 to process instructions which, when executed, perform operations for system and user software. In some embodiments, each of the one or more processor cores 807 is configured to process a specific instruction set 814. In some embodiments, instruction set 809 may facilitate Complex Instruction Set Computing (CISC), Reduced Instruction Set Computing (RISC), or computing via a Very Long Instruction Word (VLIW). Multiple processor cores 807 may each process a different instruction set 809, which may include instructions to facilitate the emulation of other instruction sets. Processor core 807 may also include other processing devices, such a Digital Signal Processor (DSP).

In some embodiments, the processor 802 includes cache memory 804. Depending on the architecture, the processor 802 can have a single internal cache or multiple levels of internal cache. In some embodiments, the cache memory is shared among various components of the processor 802. In some embodiments, the processor 802 also uses an external cache (e.g., a Level-3 (L3) cache or Last Level Cache (LLC)) (not shown), which may be shared among processor cores 807 using known cache coherency techniques. A register file 806 is additionally included in processor 802 which may include different types of registers for storing different types of data (e.g., integer registers, floating point registers, status registers, and an instruction pointer register). Some registers may be general-purpose registers, while other registers may be specific to the design of the processor 802.

In some embodiments, one or more processor(s) 802 are coupled with one or more interface bus(es) 810 to transmit communication signals such as address, data, or control signals between processor 802 and other components in the system. The interface bus 810, in one embodiment, can be a processor bus, such as a version of the Direct Media Interface (DMI) bus. However, processor buses are not limited to the DMI bus, and may include one or more Peripheral Component Interconnect buses (e.g., PCI, PCI Express), memory buses, or other types of interface buses. In one embodiment the processor(s) 802 include an integrated memory controller 816 and a platform controller hub 830. The memory controller 816 facilitates communication between a memory device and other components of the system 800, while the platform controller hub (PCH) 830 provides connections to I/O devices via a local I/O bus.

Memory device 820 can be a dynamic random-access memory (DRAM) device, a static random-access memory (SRAM) device, flash memory device, phase-change memory device, or some other memory device having suitable performance to serve as process memory. In one embodiment the memory device 820 can operate as system memory for the system 800, to store data 822 and instructions 821 for use when the one or more processors 802 execute an application or process. Memory controller hub 816 also couples with an optional external graphics processor 812, which may communicate with the one or more graphics processors 808 in processors 802 to perform graphics and media operations. In some embodiments a display device 811 can connect to the processor(s) 802. The display device 811 can be one or more of an internal display device, as in a mobile electronic device or a laptop device or an external display device attached via a display interface (e.g., DisplayPort, etc.). In one embodiment the display device 811 can be a head mounted display (HMD) such as a stereoscopic display device for use in virtual reality (VR) applications or augmented reality (AR) applications.

In some embodiments the platform controller hub 830 enables peripherals to connect to memory device 820 and processor 802 via a high-speed I/O bus. The I/O peripherals include, but are not limited to, an audio controller 846, a network controller 834, a firmware interface 828, a wireless transceiver 826, touch sensors 825, a data storage device 824 (e.g., hard disk drive, flash memory, etc.). The data storage device 824 can connect via a storage interface (e.g., SATA) or via a peripheral bus, such as a Peripheral Component Interconnect bus (e.g., PCI, PCI Express). The touch sensors 825 can include touch screen sensors, pressure sensors, or fingerprint sensors. The wireless transceiver 826 can be a Wi-Fi transceiver, a Bluetooth transceiver, or a mobile network transceiver such as a 3G, 4G, Long Term Evolution (LTE), or 5G transceiver. The firmware interface 828 enables communication with system firmware, and can be, for example, a unified extensible firmware interface (UEFI). The network controller 834 can enable a network connection to a wired network. In some embodiments, a high-performance network controller (not shown) couples with the interface bus 810. The audio controller 846, in one embodiment, is a multi-channel high definition audio controller. In one embodiment the system 800 includes an optional legacy I/O controller 840 for coupling legacy (e.g., Personal System 2 (PS/2)) devices to the system. The platform controller hub 830 can also connect to one or more Universal Serial Bus (USB) controllers 842 connect input devices, such as keyboard and mouse 843 combinations, a camera 844, or other USB input devices.

Illustrative examples of the technologies disclosed herein are provided below. An embodiment of the technologies may include any one or more, and any combination of, the examples described below.

Example 1 is a computer-implemented method, comprising initializing a compute platform in a cloud computing environment; assigning at least a first cryptographic key associated with the platform owner and a second cryptographic key associated with a workload owner to a debug/management interface of the compute platform; and encrypting device information generated by the debug/management interface of the compute platform using at least one of the first cryptographic key or the second cryptographic key.

Example 2 may include the subject matter of Example 1, further comprising receiving, from the workload owner, a request for an attestation quote for the debug/management interface; in response to the request, generating an attestation quote for the debug/management interface, and returning the attestation quote to the workload owner.

Example 3 may include the subject matter of Examples 1-2, wherein the attestation quote comprises information derived from the second public cryptography key, an indication that the debug interface is enabled, and a list of identifiers indicating one or more entities authorized to decrypt device information generated by the debug/management interface.

Example 4 may include the subject matter of Examples 1-3, further comprising configuring the debug/management interface to require requests to be signed using a cryptographic key from an authorized entity.

Example 5 may include the subject matter of Examples 1-2, further comprising receiving, from a first entity, a command to access information in the debug/management interface; decrypting the command to recover the cryptographic key from the request; and in response to a determination that that the first entity is authorized to access the debug/management interface, executing the command.

Example 6 may include the subject matter of Examples 1-5, further comprising receiving, from a first entity, a command to access information in the debug/management interface; decrypting the command to recover the cryptographic key from the request; and in response to a determination that that the first entity is authorized to access the debug/management interface, rejecting the command.

Example 7 may include the subject matter of Examples 1-6, further comprising generating an error report; and entering the first entity into a log of malicious users.

Example 8 is an apparatus comprising a processor; and a computer readable memory comprising instructions which, when executed by the processor, cause the processor to initialize a compute platform in a cloud computing environment; assign at least a first cryptographic key associated with the platform owner and a second cryptographic key associated with a workload owner to a debug/management interface of the compute platform; and encrypt device information generated by the debug/management interface of the compute platform using at least one of the first cryptographic key or the second cryptographic key.

Example 9 may include the subject matter of Example 8, further comprising instructions which, when executed by the processor, cause the processor to receive, from the workload owner, a request for an attestation quote for the debug/management interface; and in response to the request, generate an attestation quote for the debug/management interface, and return the attestation quote to the workload owner.

Example 10 may include the subject matter of Examples 8-9, wherein the attestation quote comprises information derived from the second public cryptography key, an indication that the debug interface is enabled, and a list of identifiers indicating one or more entities authorized to decrypt device information generated by the debug/management interface.

Example 11 may include the subject matter of Examples 8-10, further comprising instructions which, when executed by the processor, cause the processor to configure the debug/management interface to require requests to be signed using a cryptographic key from an authorized entity.

Example 12 may include the subject matter of Examples 8-11, further comprising instructions which, when executed by the processor, cause the processor to receive, from a first entity, a command to access information in the debug/management interface; decrypt the command to recover the cryptographic key from the request; and in response to a determination that that the first entity is authorized to access the debug/management interface, execute the command.

Example 13 may include the subject matter of Examples 8-12, further comprising instructions which, when executed by the processor, cause the processor to receive, from a first entity, a command to access information in the debug/management interface; decrypt the command to recover the cryptographic key from the request; and in response to a determination that the first entity is authorized to access the debug/management interface, reject the command.

Example 14 may include the subject matter of Examples 8-13, further comprising instructions which, when executed by the processor, cause the processor to generate an error report; and entering the first entity into a log of malicious users.

Example 15 is a computer-readable storage media comprising instructions stored thereon that, in response to being executed, cause a computing device to initialize a compute platform in a cloud computing environment; assign at least a first cryptographic key associated with the platform owner and a second cryptographic key associated with a workload owner to a debug/management interface of the compute platform; and encrypt device information generated by the debug/management interface of the compute platform using at least one of the first cryptographic key or the second cryptographic key.

Example 16 may include the subject matter of Example 15, further comprising instructions stored thereon that, in response to being executed, cause the computing device to receive, from the workload owner, a request for an attestation quote for the debug/management interface; and in response to the request, generate an attestation quote for the debug/management interface, and return the attestation quote to the workload owner.

Example 17 may include the subject matter of Examples 15-16, wherein the attestation quote comprises information derived from the second public cryptography key, an indication that the debug interface is enabled, and a list of identifiers indicating one or more entities authorized to decrypt device information generated by the debug/management interface.

Example 18 may include the subject matter of Examples 15-17, further comprising instructions stored thereon that, in response to being executed, cause the computing device to configure the debug/management interface to require requests to be signed using a cryptographic key from an authorized entity.

Example 19 may include the subject matter of Examples 15-18, further comprising instructions stored thereon that, in response to being executed, cause the computing device to receive, from a first entity, a command to access information in the debug/management interface; decrypt the command to recover the cryptographic key from the request; and in response to a determination that that the first entity is authorized to access the debug/management interface, execute the command.

Example 20 may include the subject matter of Examples 15-19, further comprising instructions stored thereon that, in response to being executed, cause the computing device to receive, from a first entity, a command to access information in the debug/management interface; decrypt the command to recover the cryptographic key from the request; and in response to a determination that the first entity is authorized to access the debug/management interface, reject the command.

Example 21 may include the subject matter of Examples 15-20, further comprising instructions stored thereon that, in response to being executed, cause the computing device to generate an error report; and enter the first entity into a log of malicious users.

The above Detailed Description includes references to the accompanying drawings, which form a part of the Detailed Description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In addition “a set of” includes one or more elements. In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim are still deemed to fall within the scope of that claim. Moreover, in the following claims, the terms “first,” “second,” “third,” etc. are used merely as labels, and are not intended to suggest a numerical order for their objects.

The terms “logic instructions” as referred to herein relates to expressions which may be understood by one or more machines for performing one or more logical operations. For example, logic instructions may comprise instructions which are interpretable by a processor compiler for executing one or more operations on one or more data objects. However, this is merely an example of machine-readable instructions and examples are not limited in this respect.

The terms “computer readable medium” as referred to herein relates to media capable of maintaining expressions which are perceivable by one or more machines. For example, a computer readable medium may comprise one or more storage devices for storing computer readable instructions or data. Such storage devices may comprise storage media such as, for example, optical, magnetic or semiconductor storage media. However, this is merely an example of a computer readable medium and examples are not limited in this respect.

The term “logic” as referred to herein relates to structure for performing one or more logical operations. For example, logic may comprise circuitry which provides one or more output signals based upon one or more input signals. Such circuitry may comprise a finite state machine which receives a digital input and provides a digital output, or circuitry which provides one or more analog output signals in response to one or more analog input signals. Such circuitry may be provided in an application specific integrated circuit (ASIC) or field programmable gate array (FPGA). Also, logic may comprise machine-readable instructions stored in a memory in combination with processing circuitry to execute such machine-readable instructions. However, these are merely examples of structures which may provide logic and examples are not limited in this respect.

Some of the methods described herein may be embodied as logic instructions on a computer-readable medium. When executed on a processor, the logic instructions cause a processor to be programmed as a special-purpose machine that implements the described methods. The processor, when configured by the logic instructions to execute the methods described herein, constitutes structure for performing the described methods. Alternatively, the methods described herein may be reduced to logic on, e.g., a field programmable gate array (FPGA), an application specific integrated circuit (ASIC) or the like.

In the description and claims, the terms coupled and connected, along with their derivatives, may be used. In particular examples, connected may be used to indicate that two or more elements are in direct physical or electrical contact with each other. Coupled may mean that two or more elements are in direct physical or electrical contact. However, coupled may also mean that two or more elements may not be in direct contact with each other, but yet may still cooperate or interact with each other.

Reference in the specification to “one example” or “some examples” means that a particular feature, structure, or characteristic described in connection with the example is included in at least an implementation. The appearances of the phrase “in one example” in various places in the specification may or may not be all referring to the same example.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with each claim standing on its own as a separate embodiment. The scope of the embodiments disclosed herein is to be determined with reference to the appended claims, along with the full scope of equivalents to which such claims are entitled.

Although examples have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. A computer-implemented method, comprising:
initializing a compute platform in a cloud computing environment;
assigning at least a first cryptographic key associated with the platform owner and a second cryptographic key associated with a workload owner to a debug/management interface of the compute platform; and
encrypting device information generated by the debug/management interface of the compute platform using at least one of the first cryptographic key or the second cryptographic key.

2. The method of claim 1, further comprising:
receiving, from the workload owner, a request for an attestation quote for the debug/management interface;
in response to the request, generating an attestation quote for the debug/management interface, and returning the attestation quote to the workload owner.

3. The method of claim 2, wherein the attestation quote comprises information derived from the second public cryptography key, an indication that the debug interface is enabled, and a list of identifiers indicating one or more entities authorized to decrypt device information generated by the debug/management interface.

4. The method of claim 1, further comprising:
configuring the debug/management interface to require requests to be signed using a cryptographic key from an authorized entity.

5. The method of claim 4, further comprising:
receiving, from a first entity, a command to access information in the debug/management interface;
decrypting the command to recover the cryptographic key from the request; and
in response to a determination that that the first entity is authorized to access the debug/management interface, executing the command.

6. The method of claim 4, further comprising:
receiving, from a first entity, a command to access information in the debug/management interface;
decrypting the command to recover the cryptographic key from the request; and
in response to a determination that that the first entity is authorized to access the debug/management interface, rejecting the command.

7. The method of claim 6, further comprising:
generating an error report; and
entering the first entity into a log of malicious users.

8. An apparatus comprising:
a processor; and
a computer readable memory comprising instructions which, when executed by the processor, cause the processor to:
initialize a compute platform in a cloud computing environment;
assign at least a first cryptographic key associated with the platform owner and a second cryptographic key associated with a workload owner to a debug/management interface of the compute platform; and
encrypt device information generated by the debug/management interface of the compute platform using at least one of the first cryptographic key or the second cryptographic key.

9. The apparatus of claim 8, comprising instructions which, when executed by the processor, cause the processor to:
receive, from the workload owner, a request for an attestation quote for the debug/management interface; and
in response to the request, generate an attestation quote for the debug/management interface, and return the attestation quote to the workload owner.

10. The apparatus of claim 9, wherein the attestation quote comprises information derived from the second public cryptography key, an indication that the debug interface is enabled, and a list of identifiers indicating one or more entities authorized to decrypt device information generated by the debug/management interface.

11. The apparatus of claim 8, comprising instructions which, when executed by the processor, cause the processor to:
configure the debug/management interface to require requests to be signed using a cryptographic key from an authorized entity.

12. The apparatus of claim 11, comprising instructions which, when executed by the processor, cause the processor to:
receive, from a first entity, a command to access information in the debug/management interface;
decrypt the command to recover the cryptographic key from the request; and
in response to a determination that that the first entity is authorized to access the debug/management interface, execute the command.

13. The apparatus of claim 11, comprising instructions which, when executed by the processor, cause the processor to:
receive, from a first entity, a command to access information in the debug/management interface;
decrypt the command to recover the cryptographic key from the request; and
in response to a determination that the first entity is authorized to access the debug/management interface, reject the command.

14. The apparatus of claim 13, comprising instructions which, when executed by the processor, cause the processor to:
generate an error report; and
entering the first entity into a log of malicious users.

15. One or more computer-readable storage media comprising instructions stored thereon that, in response to being executed, cause a computing device to:
initialize a compute platform in a cloud computing environment;
assign at least a first cryptographic key associated with the platform owner and a second cryptographic key associated with a workload owner to a debug/management interface of the compute platform; and
encrypt device information generated by the debug/management interface of the compute platform using at least one of the first cryptographic key or the second cryptographic key.

16. The one or more computer-readable storage media of claim 15, further comprising instructions stored thereon that, in response to being executed, cause the computing device to:
receive, from the workload owner, a request for an attestation quote for the debug/management interface;
in response to the request, generate an attestation quote for the debug/management interface, and return the attestation quote to the workload owner.

17. The one or more computer-readable storage media of claim 16, wherein the attestation quote comprises information derived from the second public cryptography key, an indication that the debug interface is enabled, and a list of identifiers indicating one or more entities authorized to decrypt device information generated by the debug/management interface.

18. The one or more computer-readable storage media of claim 15, further comprising instructions stored thereon that, in response to being executed, cause the computing device to:
configure the debug/management interface to require requests to be signed using a cryptographic key from an authorized entity.

19. The one or more computer-readable storage media of claim 19, further comprising instructions stored thereon that, in response to being executed, cause the computing device to:
receive, from a first entity, a command to access information in the debug/management interface;
decrypt the command to recover the cryptographic key from the request; and
in response to a determination that that the first entity is authorized to access the debug/management interface, execute the command.

20. The one or more computer-readable storage media of claim 19, further comprising instructions stored thereon that, in response to being executed, cause the computing device to:
receive, from a first entity, a command to access information in the debug/management interface;
decrypt the command to recover the cryptographic key from the request; and
in response to a determination that the first entity is authorized to access the debug/management interface, reject the command.

21. The one or more computer-readable storage media of claim 15, further comprising instructions stored thereon that, in response to being executed, cause the computing device to:
generate an error report; and
enter the first entity into a log of malicious users.
